(19) United States
(12) Patent Application Publication
(10) Pub. No.: US 2016/0142522 A1
(43) Pub. Date: May 19, 2016

(54) CASE HAVING TRANSPARENT BACK PLATE FOR ELECTRONIC DEVICES

(71) Applicant: Dae-Young KIM, Seoul (KR)

(72) Inventor: Dae-Young KIM, Seoul (KR)

(21) Appl. No.: 14/638,964

(22) Filed: Mar. 4, 2015

Related U.S. Application Data
(60) Provisional application No. 62/079,920, filed on Nov. 14, 2014.

(51) Int. Cl. H04M 1/02

(52) U.S. Cl. CPC H04M 1/0249

(57) ABSTRACT

A case for an electronic device includes a protective shell and a side enclosure frame and the protective shell includes a transparent back plate and side wall. The side enclosure frame is adapted to removably mount over the side wall of the protective shell. The side wall is made of soft material and the side enclosure frame is made of hard material. A mating recess and a protrusion are respectively longitudinally formed on the side wall and side enclosure frame and the protrusion is mated with the mating recess. The protective shell may be made by a double shot injection molding. Alternatively, the protective shell may be made by: first, cutting a plate to make the back plate, and then, performing injection molding onto the back plate along edges of the back plate to form the side wall.

### CROSS-REFERENCE TO RELATED APPLICATIONS

This application claims priority to U.S. provisional patent application No. 62/079,920 filed Nov. 14, 2014, and U.S. provisional patent application No. 62/140,680 filed Mar. 31, 2015, each of which are incorporated herein by reference in their entirety.

### FIELD OF THE INVENTION

The present invention relates to a case having a transparent back plate for an electronic device and, more particularly, to a mobile phone case having a side enclosure frame and a protective shell. The protective shell, including the transparent back plate and a side wall, is made by a double shot injection molding. Because of the transparent back plate, a logo, trademark or emblem on a back portion of a mobile electronic device is visible even when the device is mounted in a case.

### BACKGROUND OF THE INVENTION

Mobile electronic devices such as mobile phones, smart phones, tablet computers and the like are in wide use around the world. These electronic devices are intended to be carried or moved about and as such, these devices are more likely to be accidentally dropped, hit, or scratched. Thus, users of the mobile electronic devices use cases to protect their devices and manufacturers have produced different types of cases to help the users keep their mobile devices safe.

Certain mobile electronic devices such as iPhone have a stylish logo, trademark or emblem on the back portion of the device and if such device is mounted on a case, the logo or emblem on the back portion of the device is not visible from outside.

Therefore, to solve the above problems, there is a need for a case having a transparent back plate and providing a secure protection of a mobile electronic device. This invention is directed to solve these problems and satisfy the long-felt need.

### SUMMARY OF THE INVENTION

The present invention contrives to solve the disadvantages of the prior art. The present invention provides a case having a transparent back plate so that a logo, trademark or emblem on a back portion of an electronic device can be visible from outside.

The object of the invention is to provide a case for an electronic device having a transparent back plate. The case includes a protective shell and a side enclosure frame. The protective shell includes the back plate and a side wall and the side enclosure frame is adapted to removably mount over the side wall of the protective shell. The protective shell significantly covers a back portion and a side portion of the electronic device for protecting the electronic device and the side enclosure frame continuously wraps around the side wall of the protective shell to apply pressure toward a direction of the electronic device for providing secure and tight engagement of the protective shell with the electronic device. The side enclosure frame is made of hard material and provides an additional protection to the electronic device. Because of the side enclosure frame, the border between the back plate and the side wall is less vulnerable to crack or damage.

Another object of the invention is to provide a case having a transparent back plate for an electronic device. The case includes a protective shell and a side enclosure frame and the protective shell includes the back plate and a side wall. The side wall has a lower ledge outwardly extending from a bottom of the side wall. A mating recess is longitudinally formed on or right above the lower ledge and a protrusion is longitudinally is formed on the side enclosure frame. The protrusion is mated with the mating recess for providing secure engagement of the protective shell with the side enclosure frame. Additionally, the side wall may have an upper ledge outwardly extending from a top of the side wall.

Still another object of the invention is to provide a case having a transparent back plate for an electronic device. The case includes a protective shell and a side enclosure frame and the protective shell includes the back plate and a side wall. The side wall is made of soft material and the side enclosure frame is made of hard material. The back plate is preferably made of polycarbonate or acryl. The protective shell may be made by a double shot injection molding, the back plate made by a first shot injection and the side wall made by a second shot injection. Alternatively, the protective shell may be made by: first, cutting a plate to make the back plate, and then, performing injection molding onto the back plate along edges of the back plate to form the side wall.

Still another object of the invention is to provide a case having a protective shell, a side enclosure frame, and a shock absorbing block. The shock absorbing block is constructed to have a plurality of recesses formed on the side wall of the protective shell such that adjacent recesses are separated by a partition. The recesses are rectangular and the plurality of recesses has a continuous unitary construction along lower part of the four sides of the protective shell.

The advantages of the present invention are: (1) in present invention, the back plate of the protective shell is transparent or translucent and thus, a logo, trademark or emblem on the back portion of an electronic device is visible even when the electronic device is installed in the case; (2) the protective shell, having the back plate and side wall, is durable and the side wall is flexible enough for the electronic device to be inserted therein; (3) a mating recess and a protrusion are respectively longitudinally formed on the side wall and side enclosure frame, the protrusion being mated with the mating recess for providing secure engagement of the protective shell with the side enclosure frame and preventing slipping of the electronic device out of the case; (4) the protective shell is made by an injection molding and the bonding between the back plate and side wall is very strong; (5) the case of the present invention is comprised of the back plate, the side wall made of soft material, and the side enclosure frame made of hard material such that the bonding between the back plate and side wall is very strong and secure and the side enclosure frame provides secure and tight engagement of the case with the electronic device; (6) the border between the back plate and side wall is less vulnerable to crack or damage because of the side enclosure frame; (7) the side wall of the protective shell has a shock absorbing structure to efficiently absorb impacts from outside; and (8) in present invention, the back plate of the protective shell is coated or a film is attached to the back plate for preventing smudge between the back plate and the back portion of the electronic device.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 shows a front perspective view of an electronic device such as cell phone or a smart phone;

FIG. 2 shows a rear perspective view of the electronic device of FIG. 1;

FIG. 3 shows a rear perspective view of the electronic device installed and secured in a case of the present invention;

FIG. 4 shows a rear view of the electronic device installed and secured in the case of the present invention in FIG. 3;

FIG. 5 shows an exploded view of the case according to one embodiment of the invention illustrating a side enclosure frame and a protective shell in that the protective shell includes a transparent back plate and a side wall;

FIG. 6 shows a front view of the protective shell of the case according to one embodiment of the invention;

FIG. 7 shows a rear view of the protective shell of the case according to one embodiment of the invention;

FIG. 8 shows a left side view of the protective shell of the case according to one embodiment of the invention;

FIG. 9 shows a right side view of the protective shell of the case according to one embodiment of the invention;

FIG. 10 shows a top view of the protective shell of the case according to one embodiment of the invention;

FIG. 11 shows a bottom view of the protective shell of the case according to one embodiment of the invention;

FIG. 12 shows a front view of the side enclosure frame of the case according to one embodiment of the invention;

FIG. 13 shows a rear view of the side enclosure frame of the case according to one embodiment of the invention;

FIG. 14 shows a left side view of the side enclosure frame of the case according to one embodiment of the invention;

FIG. 15 shows a right side view of the side enclosure frame of the case according to one embodiment of the invention;

FIG. 16 shows a top view of the side enclosure frame of the case according to one embodiment of the invention;

FIG. 17 shows a bottom view of the side enclosure frame of the case according to one embodiment of the invention;

FIG. 18 shows a cross-sectional view of the case illustrating the side enclosure frame, hard protective shell and electronic device installed in the case according to one embodiment of the present invention; and

FIG. 19 shows a perspective view of the electronic device and the case in that the back plate of the case is coated.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

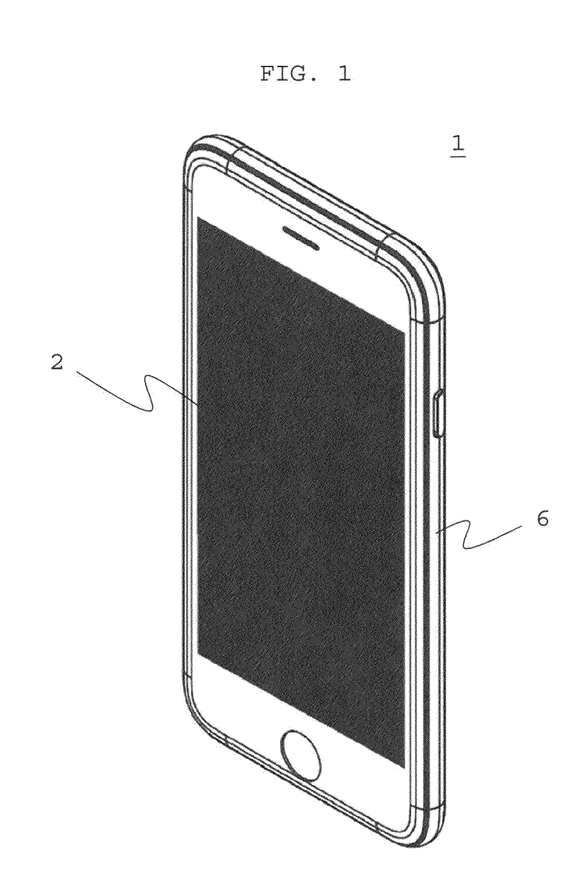

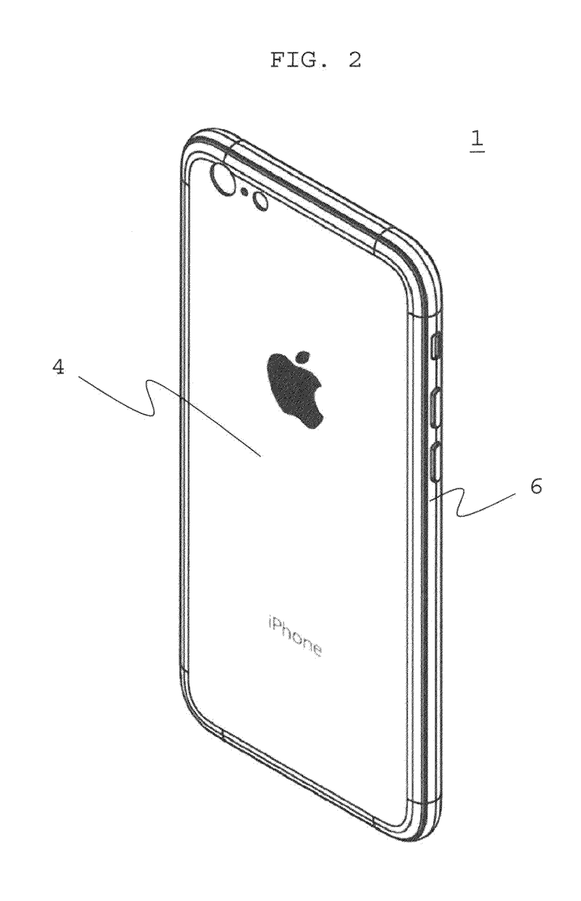

FIGS. 1 and 2 respectively show front and rear perspective views of an electronic device 1 such as a cell phone, smart phone, tablet computing device, or the like. FIGS. 1 and 2 show iPhone™, more specifically iPhone 6™. The electronic device 1 has a front portion 2, back portion 4, and side portion 6 and a screen is located on the front portion 2 as shown in FIG. 1. The back portion 4 may have a logo, trademark or emblem such as the Apple Logo™ and the word iPhone™ as shown in FIG. 2 and electronic device users may wish the logo, trademark or emblem to be visible even when the electronic device 1 is mounted in a case 100.

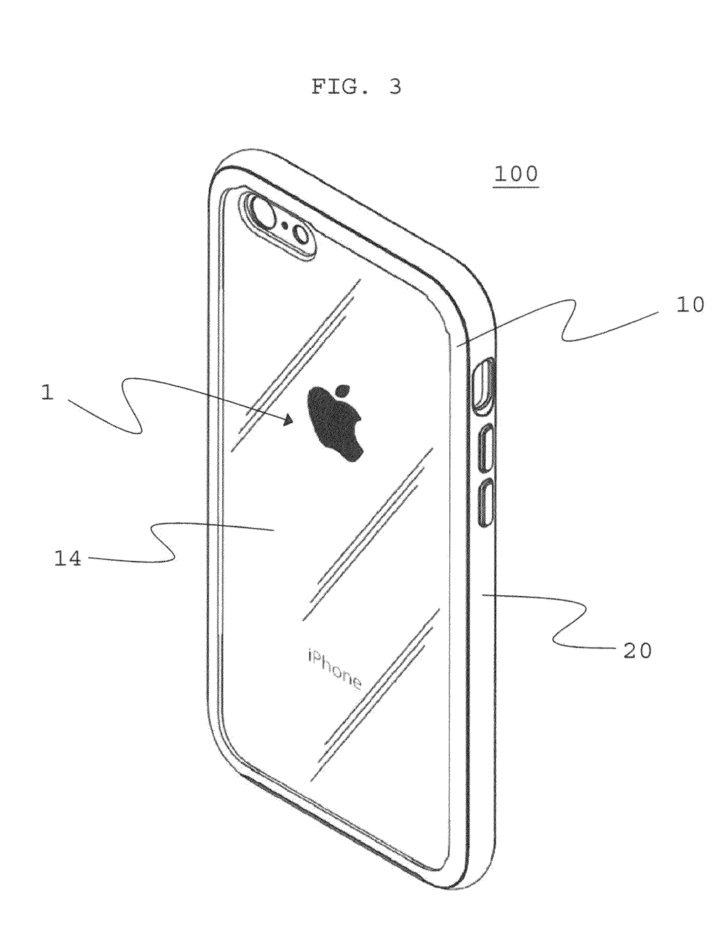

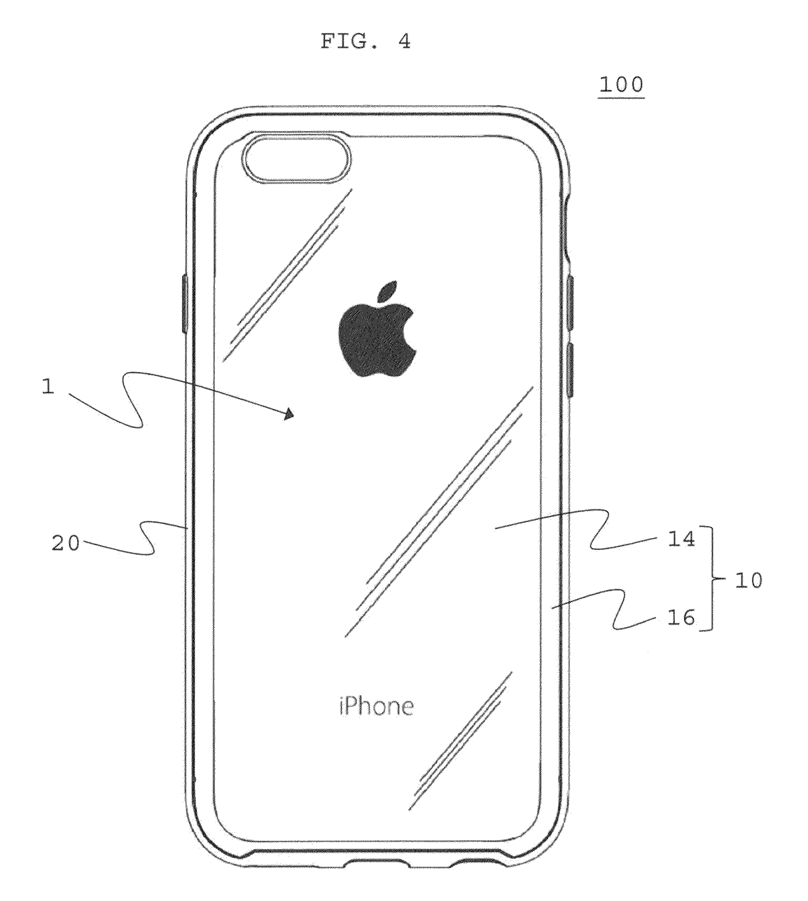

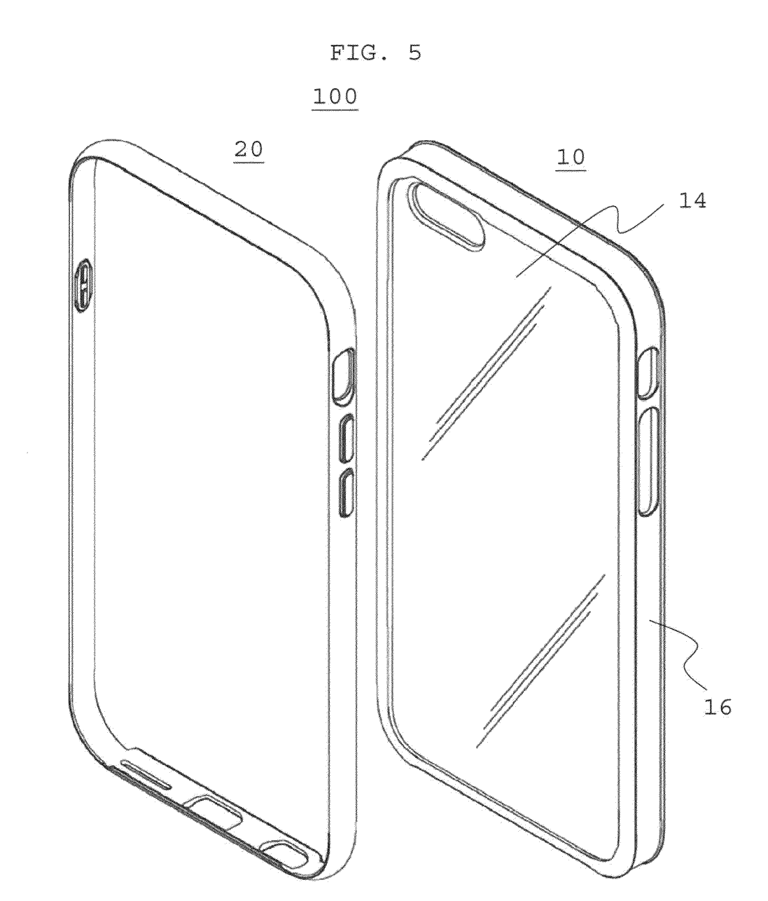

FIG. 3 shows a rear perspective view of the electronic device 1 of FIG. 1 installed and secured in a case 100 of the present invention. The back plate 14 of the case 100 is transparent or translucent and thus, the Apple™ logo and the trademark “iPhone” are visible through the back plate. FIG. 4 shows a rear view of FIG. 3 and FIG. 5 shows an exploded view of the case 100 illustrating the side enclosure frame 20 and the protective shell 10. The protective shell 10 includes the back plate 14 and side wall 16.

A case 100, having a transparent or translucent back plate 14, for an electronic device 1, includes a protective shell 10 having a back plate 14 and side wall 16 for protecting the electronic device 1 installed therein and a side enclosure frame 20 configured to removably mount over the side wall 16 of the protective shell 10. The protective shell 10 significantly covers a back portion 4 and a side portion 6 of the electronic device 1 and does not significantly cover a front portion 2 of the electronic device 1. The back plate 14 covers the back portion 4 of the electronic device 1 and the side wall 16 extends from the back plate 14 to cover the side portion 6 of the electronic device 1. The back plate 14 is transparent or translucent and thus, the back portion 4 of the electronic device 1 is visible even when the electronic device 1 is installed and secured in the case 100.

The side enclosure frame 20 continuously wraps around the side wall 16 of the protective shell 10 to apply pressure toward a direction of the electronic device 1, thereby preventing slipping of the electronic device 1 out of case 100. Additionally, the side enclosure frame 20 prevents the boundary between the back plate 14 and side wall 16 from cracking and provides an additional protection to the electronic device 1. Without the side enclosure frame 20, the boundary between the back plate 14 and side wall 16 is more vulnerable to crack or damage.

Preferably, the back plate 14 covers substantially all back portion 4 of the electronic device 1 and the side wall 16 covers an outer rim of the back plate 14 as shown in FIG. 3.

The side enclosure frame 20 may have a protrusion (not shown) and the side wall 16 may have a mating recess (not shown) such that the protrusion is received by or mated with the mating recess for secure coupling between the protective shell 10 and the side enclosure frame 20 and preventing the side enclosure frame 20 from slipping out of the protective shell 10. Additionally, this construction of the protrusion and mating recess is advantageous in absorbing and distribute impact throughout the side wall 16 when an impact is inflicted on the case 100.

In addition, the side wall 16 may further comprises a lower ledge 19 outwardly extending from a bottom of the side wall 16. The mating recess may be longitudinally formed on or right above the lower ledge 19 and the protrusion may be longitudinally formed on the side enclosure frame 20 along about the lower edge of the side enclosure frame 20. Additionally or alternatively, the side wall 16 may further comprise an upper ledge 18 outwardly extending from a top of the side wall 16. The mating recess may be longitudinally formed on or right beneath (or below) the upper ledge 18 and the protrusion may be longitudinally formed on the side enclosure frame 20 along about the upper edge of the side enclosure frame 20.

In another embodiment, the side wall 16 may comprise an upper ledge 18 outwardly extending from a top of the side wall 16 and a lower ledge 19 outwardly extending from a bottom of the side wall 16. Thus, a groove is formed on the side wall 16 by the upper ledge 18 and the lower ledge 19 for receiving the side enclosure frame 20 therein. The side enclosure frame 20 may have a protrusion (not shown) and the side wall 16 may have a mating recess (not shown) such that the protrusion is received by or mated with the mating recess. Preferably, the mating recess is longitudinally formed on or right beneath the upper ledge 18 and the protrusion is longitudinally formed on the side enclosure frame 20. Additionally or alternatively, the mating recess is longitudinally formed on or right above the lower ledge 19 and the protrusion is longitudinally formed on the side enclosure frame 20.

The protective shell 10 is made by a double shot injection molding. For example, the back plate 14 is made of transparent or translucent plastic and the side wall 16 is made of thermoplastic polyurethane. The back plate 14 is made by a first shot injection and the side wall 16 is made by a second shot injection. In this way, the back plate 14 may or may not be flat. The back plate 14 may be flat or rounded or partially rounded, or circular, preferably conforming to the back portion 4 of the electronic device 1. The back plate 14 is made by molding and thus, various shapes are possible. The back plate 14 may be transparent or translucent or semi-opaque so that a logo, trademark or emblem on the back portion 4 of the electronic device 1 can be visible through the back plate 14.

Alternatively, the back plate 14 may be made by cutting a plate and then, the side wall 16 is made by injection molding onto the back plate 16 along edges of the back plate 16. The back plate 14 may be made by cutting a pre-existing flat (plastic) panel into a specifically desired shape and then the side wall 16 is formed by injection molding onto the back plate 14. In this method, the back plate 14 is generally flat because it is cut from a flat plate and it may not be easy to form various shapes. The back plate 14 is preferably made of transparent or translucent plastic and the side wall 16 may be made of thermoplastic polyurethane. Preferably, the back plate 14 is cut from a panel using NC (Numerical Control) cutting. Numerical control is the automation of machine tools that are operated by precisely programmed commands, and thus, the cutting is very precise.

The back plate 14 is preferably made of transparent or translucent plastics such as polycarbonate, Acrylic (polymethlamethacrylate), Butyrate (cellulose acetate butyrate), Lexan (polycarbonate), PETG (glycol modified polyethylene terphthalate), Styrene, ABS, ABS-FR, conductive ABS, polyenthylene, polypropylene, transparent or translucent polymers or the like. More preferably, the back plate 14 is made of polycarbonate or acryl.

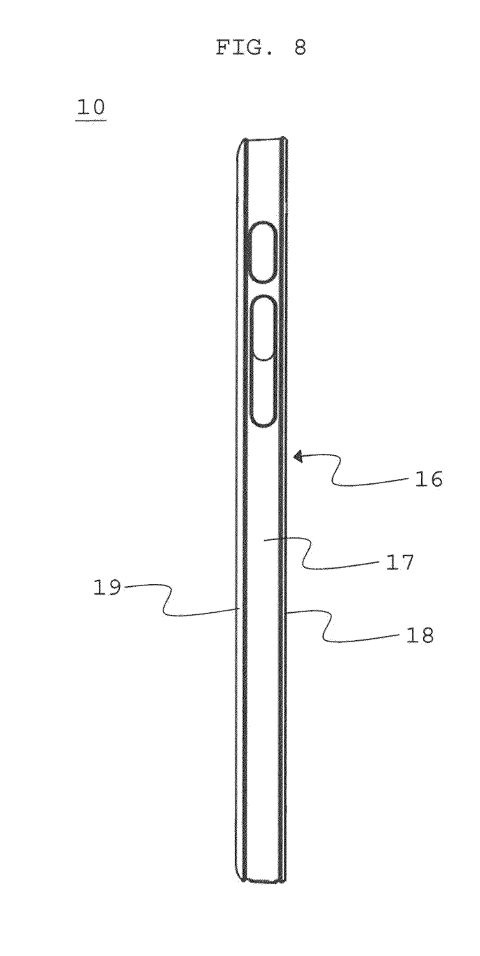

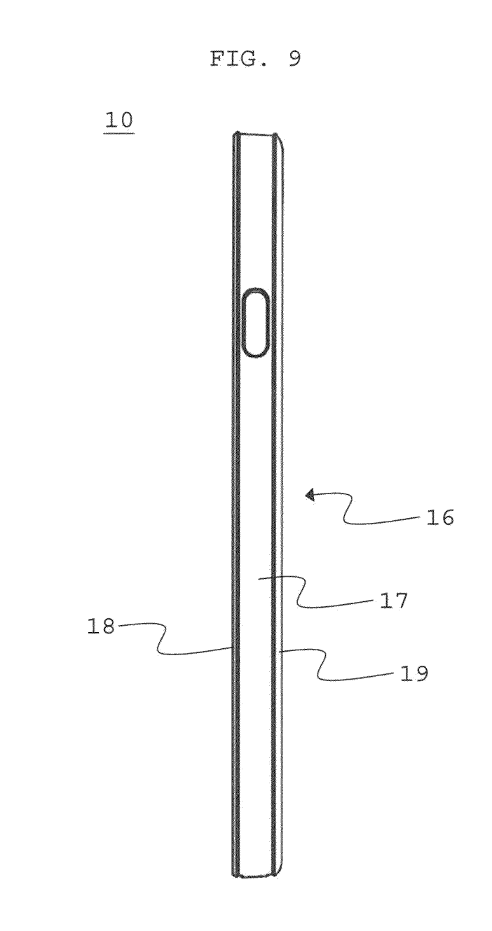

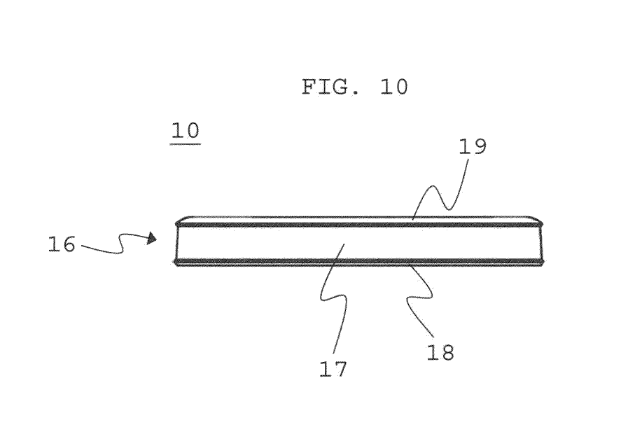

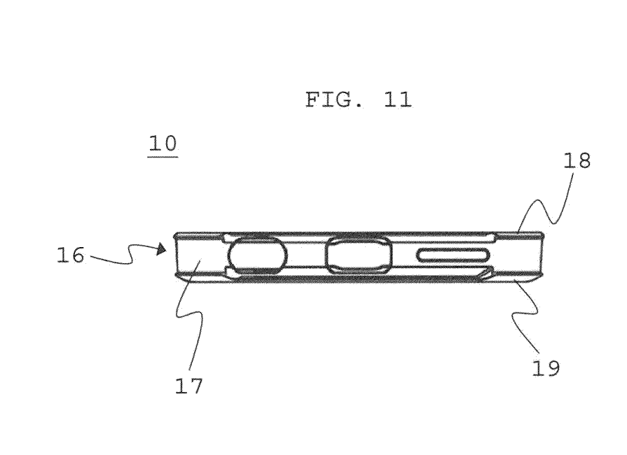

The side wall 16 may comprise a receiving groove 17 to receive the side enclosure frame 20 therein. As shown in FIGS. 8, 9, 10 and 11, the side wall 16 comprises an upper ledge 18 outwardly extending from a top of the side wall 16 and a lower ledge 19 outwardly extending from a bottom of the side wall 16 such that the upper ledge 18, the lower ledge 19, and the side wall 16 form a groove 17 to receive the side enclosure frame 20.

Side enclosure frame 20 may have a protrusion (not shown) and the side wall 16 may have a mating recess (not shown) such that the protrusion is mated with or received by the mating recess. Preferably, the protrusion and mating recess are longitudinal and the mating recess may be longer than the protrusion.

The mating recess may be longitudinally formed right beneath the upper ledge 18 and the protrusion may be longitudinally formed on the side enclosure frame 20, being received in the mating recess. Alternatively or additionally, the mating recess may be longitudinally formed right above the lower ledge 19 and the protrusion may be longitudinally formed on the side enclosure frame 20, being received in the mating recess.

The side portion 6 of the electronic device 1 is generally provided with various function keys necessary to effectively use the device and various connectors for connection with other devices. In embodiments of the present invention, apertures may be formed in portions of the side enclosure frame 20 and the protective shell 10 corresponding to the positions of the function keys and connecters of the electronic device 1 to be exposed as a space for allowing the function keys and connectors to be able to operate and connect.

As in FIG. 8, the side enclosure frame 20 continuously wraps around the side wall 16 to apply pressure toward a direction of the electronic device 1. The side enclosure frame 20 applies pressure to the direction of the electronic device from all four sides for secure coupling between the protective shell 10 and the side enclosure frame 20.

The side wall 16 may be made of soft material and the side enclosure frame 20 may be made of hard material. The side wall 16 is made of soft material for easy insertion of the electronic device 1 into the protective shell 10 and the side enclosure frame 20 is made of hard material for secure and tight engagement of the case 100 with the electronic device 1.

The side enclosure frame 20 may be made of polycarbonate. Alternatively, the side enclosure frame 20 may be made of metal or more preferably, made of aluminum.

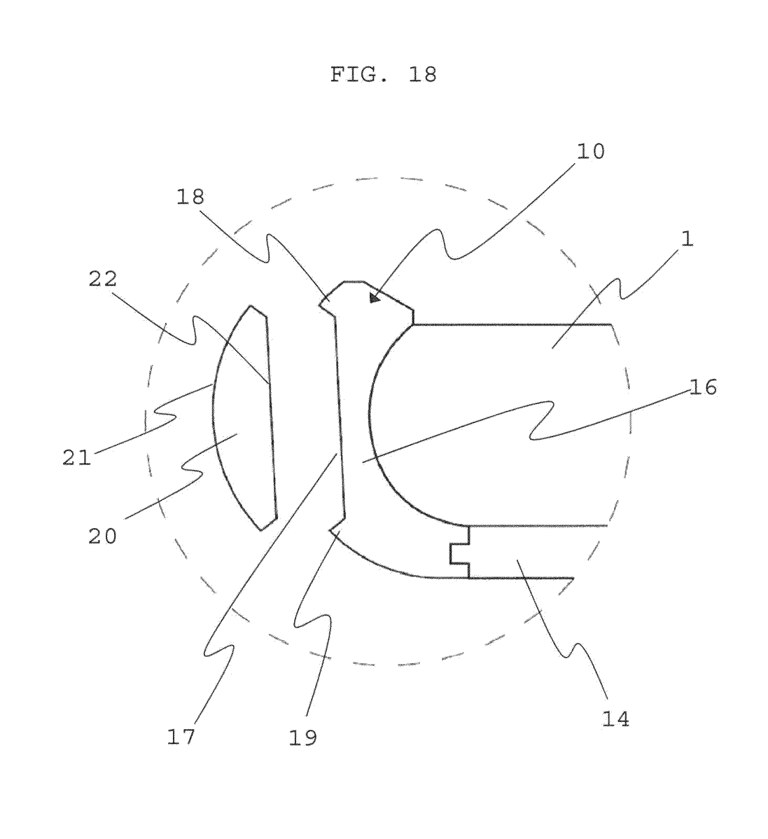

As in FIG. 18, the side enclosure frame 20 may have an outer side 21 and an inner side 22. The outer side 21 may be rounded or in a shape of a circular segment. In addition, the inner side 22 of the side enclosure frame 20 may be substantially flat. Thus, the side enclosure frame 20 is thicker in its middle and becomes thinner toward edges of it. FIG. 18 shows an example of a cross-section of the side enclosure frame 20 substantially in a shape of a circular segment. This construction is especially suitable and advantageous for an electronic device 1 having a circular side portion 6 such as iPhone 6™.

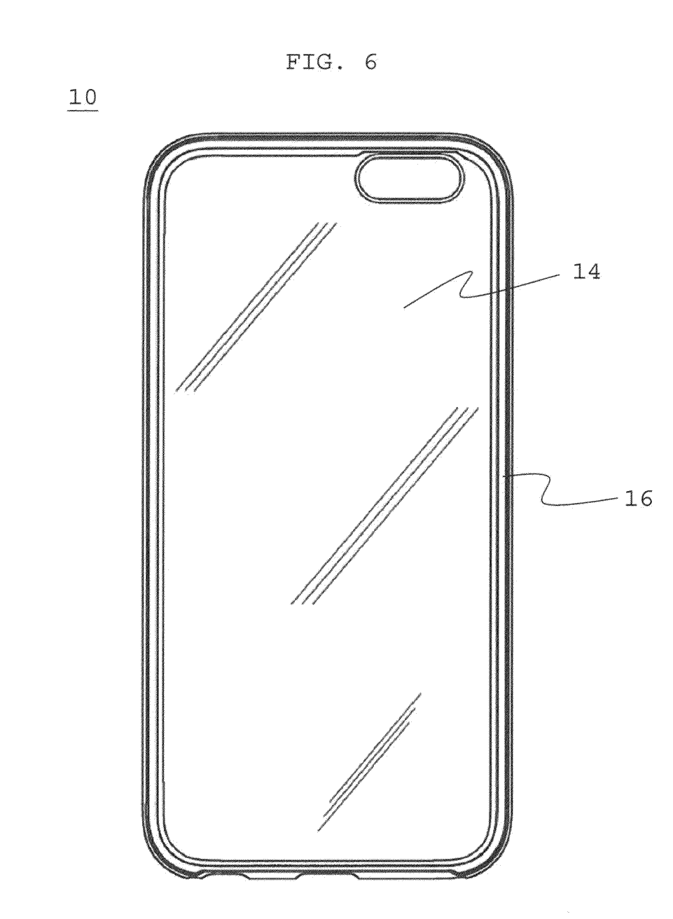

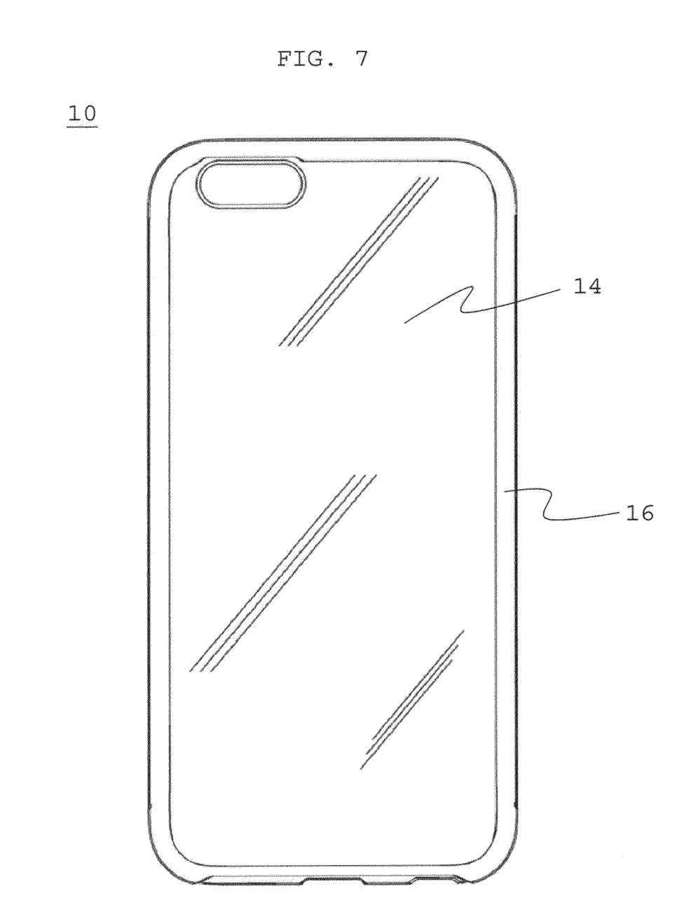

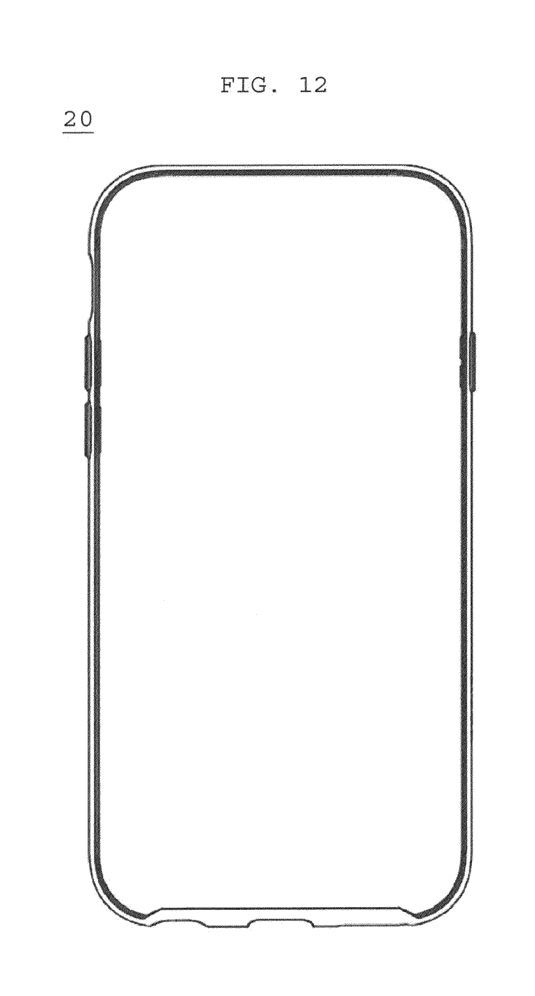

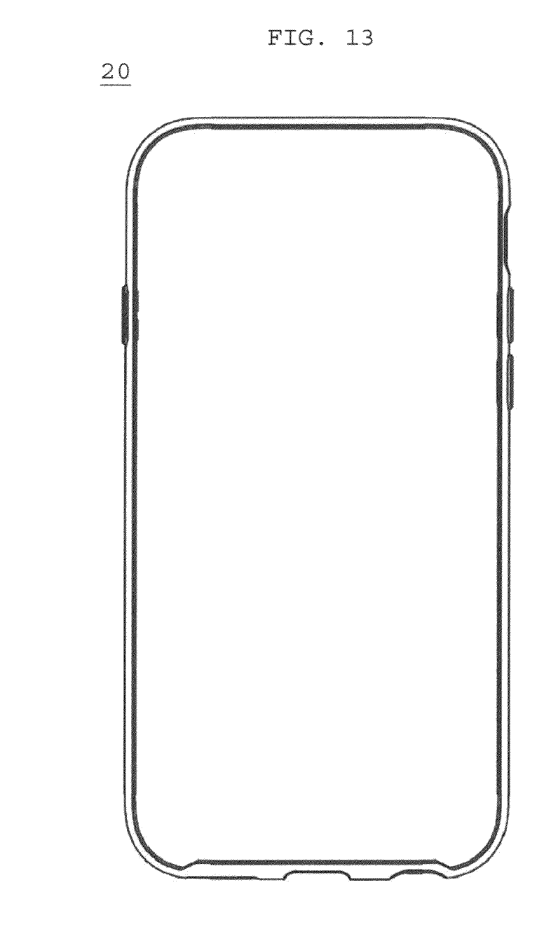

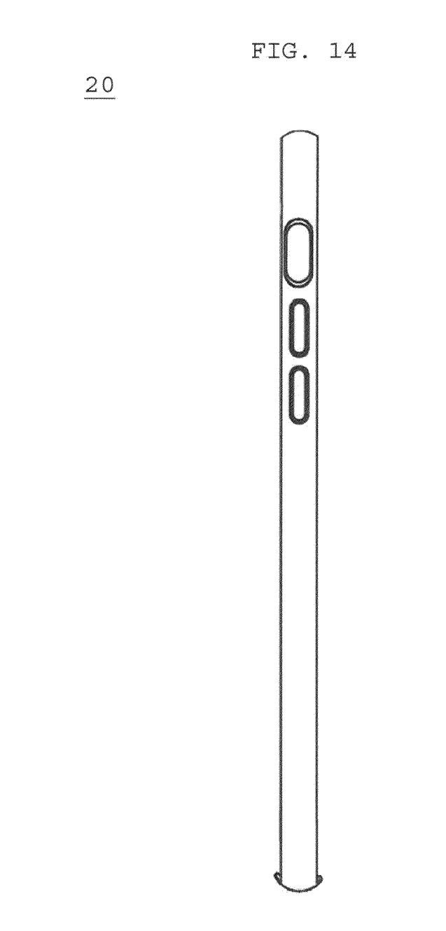

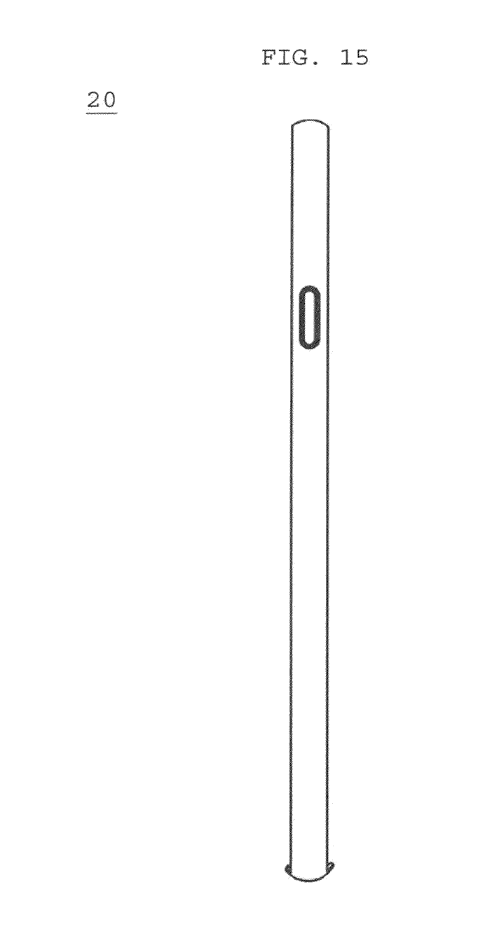

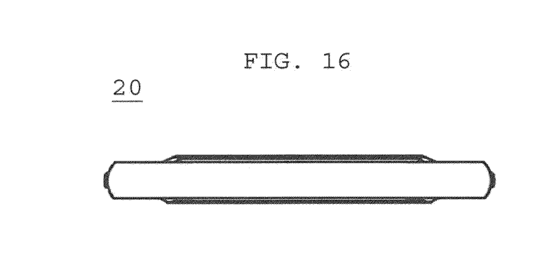

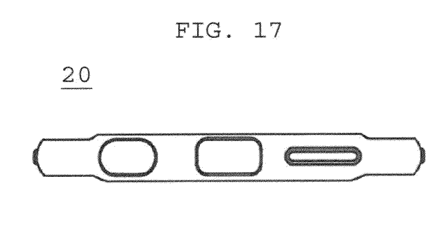

FIGS. 6 through 11 respectively show front, rear, left side, right side, top and bottom views of the protective shell 10 of the case 100. In addition, FIGS. 12 through 17 respectively show front, rear, left side, right side, top and bottom views of the side enclosure frame 20 of the case 100.

FIG. 18 shows a cross-sectional view of the case 100 illustrating the side enclosure frame 20, the hard protective shell 10 and the cell phone 1 according to one embodiment of the present invention. The side enclosure frame 20 may be formed in a number of different shapes.

The back plate 14 may be coated and preferably, at least one side of the back plate 14 is hard-coated. Hard coating provides outstanding wear resistance to the back plate 14.

In addition, a protective film may be attached to at least one side of the back plate 14 to protect the back plate 14 from scratches or other damages and a user needs to remove the protective before installing a mobile phone to the case 100.

The side wall 16 may further comprise a shock absorbing block (not shown) and the shock absorbing block may comprise a plurality of recesses (not shown) formed on the side wall 16. Preferably, adjacent recesses are separated by a partition and the recesses of the shock absorbing block are aligned along a lower part of the side wall 16. U.S. patent application Ser. No. 14/201,548 discloses description on the shock absorbing block and the content of which is incorporated herein by reference.

In the embodiment having the shock absorbing structure, the case 100 comprises a protective shell 10, a side enclosure frame 20, and a shock absorbing block (not shown). The protective shell 10 protects the electronic device installed therein without significantly covering a front portion 2 of the electronic device 1 and the side enclosure frame 20 is configured to removably mount over the side wall 16 of the protective shell 10. The shock absorbing block is constructed to have a plurality of recesses formed on the side wall 16 of the protective shell 10 such that adjacent recesses are separated by a partition.

The recesses may be rectangular and the plurality of recesses may have a continuous unitary construction along lower part of the four sides 16 of the protective shell 10 except apertures for function keys and connectors.

In addition, a shock absorbing recess may be formed on or about an inner corner where two inner-facing surfaces of adjacent side walls 16 of the protective shall 10 meet. The shock absorbing recess may be formed longitudinally about along the inner corner and the shock absorbing recess may taper toward a recess bottom.

The embodiment of the present invention having the shock absorbing structure or the shock absorbing recess has the advantages that: (1) the case has a two-part structure of a protective shell and a side enclosure frame and the protective shell has a shock absorbing structure to efficiently absorb impacts from outside; (2) in addition to the shock absorbing function, the shock absorbing recesses receive protrusions of the side enclosure frame for a secure engagement of the side enclosure frame with the protective shell; (3) the lower ledges of the side wall of the protective shell not just help secure engagement of the side enclosure frame with the protective shell, but also allow the impact to the case to spread toward the shock absorbing structure; (4) the shock absorbing structure of the present invention is configured to effectively absorb impacts to the case; (5) the groove pattern formed on the protective shell prevents slipping of a mobile phone and supplements the shock absorbing function; (6) in another embodiment of the present invention, the case includes a shock absorbing recess formed at the corner of the side wall and the shock absorbing recess at the corner absorbs and distributes impact to the corner of the case to the side walls; (7) the shock absorbing recess at the corner of the side wall tapers towards its recess bottom and its inlet is rounded, and thus, the shock absorbing recess bends or crooks to absorb and distribute the impact to the case to the side walls of the case; and (8) the concave and/or convex structure of the shock absorbing recess helps improve the shock absorbing or distributing function of the recess.

FIG. 19 shows a perspective view of the electronic device and the case in that the back plate of the case is coated.

The inner surface of the back plate is coated with a coating for preventing smudge between the back plate and the back portion of the electronic device. The coating prevents smudge(s) or makes them less visible. In this application, “preventing smudge” includes “making smudge less visible”, in addition to preventing, removing or avoiding smudge or smearing.

The coating may be printed with a transparent dot array pattern as shown in FIG. 2. The transparent dot array pattern may be printed using a UV (Ultra Violet) curable ink or silicone.

The coating may be made of transparent UV (Ultra Violet) curing material, (transparent) UV curable material, acrylic, polyurethane, or the like as long as it is effective in preventing smudges appearing between the back plate and the electronic device.

The coating may be a hard coating.

In another embodiment, a matte PET (polyethylene terephthalate) film may be attached to the inner surface of the back plate for preventing smudge between the back plate and the back portion of the electronic device. Alternatively, the matte PET (polyethylene terephthalate) film may be attached to the back portion of the electronic device for preventing smudge between the back plate and the back portion of the electronic device. A matte PET is a PET having a matte finish, and FIG. 3 shows such a matte PET.

In still another embodiment, the inner surface of the back plate may have a certain shape for preventing smudges between the back plate and the back portion of the electronic device. For example, the inner surface of the back plate may have a plurality of protrusions or embosses. Such protrusions or embosses may be formed on the entire inner surface of the back plate or a portion thereof. In addition, the inner surface of the back plate may have a matte finish. The matte finish may be applied to the entire inner surface of the back plate or a portion thereof—for example, the matte finish may be applied to the protrusions or embosses only so that they become more conspicuous. All or part of the protrusions or embosses may form letters or specific design pattern(s).

The protrusions or embosses may be formed on the inner surface of the back plate by printing them on the back plate, or cutting the inner surface of the back plate, or molding the back plate so that the back plate has the protrusions or embosses.

The protrusion or embosses may be made using Laser on the molded back plate. Or, the inner surface of the molded back plate may be treated to form small protrusions or embosses.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A case, having a transparent back plate, for an electronic device, comprising:
a protective shell, having a back plate and a side wall, for protecting the electronic device installed therein wherein the protective shell significantly covers a back portion and a side portion of the electronic device and does not significantly cover a front portion of the electronic device; and
a side enclosure frame configured to removably mount over the side wall of the protective shell;
wherein the back plate significantly covers the back portion of the electronic device and the side wall extends from the back plate to cover the side portion of the electronic device;
wherein the back plate is transparent or translucent,
wherein the side wall is made of soft material and the back plate is made of hard material.

2. The case of claim 1, wherein the side enclosure frame continuously wraps around the side wall of the protective shell to apply pressure toward a direction of the electronic device.

3. The case of claim 1, wherein the back plate covers substantially all back portion of the electronic device and the side wall covers an outer rim of the back plate.

4. The case of claim 1, wherein the side enclosure frame has a protrusion and the side wall has a mating recess such that the protrusion is received by or mated with the mating recess.

5. The case of claim 4, wherein the side wall comprises a lower ledge outwardly extending from a bottom of the side wall.

6. The case of claim 5, wherein the mating recess is longitudinally formed right above the lower ledge and the protrusion is longitudinally formed on the side enclosure frame.

7. The case of claim 4, wherein the side wall comprises an upper ledge outwardly extending from a top of the side wall.

8. The case of claim 7, wherein the mating recess is longitudinally formed right beneath the upper ledge and the protrusion is longitudinally formed on the side enclosure frame.

9. The case of claim 1, wherein the side wall comprises an upper ledge outwardly extending from a top of the side wall and a lower ledge outwardly extending from a bottom of the side wall,
wherein a groove is formed on the side wall by the upper ledge and the lower ledge for receiving the side enclosure frame therein.

10. The case of claim 9, wherein the side enclosure frame has a protrusion and the side wall has a mating recess such that the protrusion is received by or mated with the mating recess.

11. The case of claim 10, wherein the mating recess is longitudinally formed right beneath the upper ledge and the protrusion is longitudinally formed on the side enclosure frame.

12. The case of claim 10, wherein the mating recess is longitudinally formed right above the lower ledge and the protrusion is longitudinally formed on the side enclosure frame.

13. The case of claim 1, wherein the side wall is made of soft material and the side enclosure frame is made of hard material.

14. The case of claim 13, wherein the side enclosure frame is made of polycarbonate.

15. The case of claim 13, wherein the side enclosure frame is made of metal or aluminum.

16. The case of claim 1, wherein the back plate is made of transparent plastic and the side wall is made of thermoplastic polyurethane.

17. The case of claim 16, wherein the protective shell is made by a double shot injection molding.

18. The case of claim 17, wherein the back plate is made by a first shot injection and the side wall is made by a second shot injection.

19. The case of claim 1, wherein the back plate is made by cutting a plate and then, the side wall is made by injection molding onto the back plate along edges of the back plate.

20. The case of claim 19, wherein the back plate is made by NC (Numerical Control) cutting.

21. The case of claim 1, wherein the back plate is made of polycarbonate or acryl.

22. The case of claim 1, wherein the back plate is coated.

23. The case of claim 1, wherein at least one side of the back plate is hard-coated.

24. The case of claim 1, wherein a protective film is attached to at least one side of the back plate to protect the back plate from scratches or other damages and the protective film is removed before mounting and installing the electronic device in the case.

25. The case of claim 1, wherein an outer side of the side enclosure is rounded or in a shape of a circular segment.

26. The case of claim 25, wherein an inner side of the side enclosure is substantially flat.

27. The case of claim 1, wherein the side wall comprises a shock absorbing block,
wherein the shock absorbing block comprises a plurality of recesses formed on the side wall and adjacent recesses are separated by a partition,
wherein the recesses of the shock absorbing block are aligned along a lower part of the side wall.

28. The case of claim 1, wherein the side wall comprises a shock absorbing recess formed on or about an inner corner where two inner-facing surfaces of adjacent side walls of the protective shall meet.

29. A case, having a transparent back plate, for an electronic device, comprising:
a protective shell, having a back plate and a side wall, for protecting the electronic device installed therein wherein the protective shell significantly covers a back portion and a side portion of the electronic device and does not significantly cover a front portion of the electronic device; and
wherein the back plate is transparent or translucent,
wherein the back plate has an inner surface and an outer surface wherein the inner surface faces the electronic device,
wherein the side wall is made of soft material and the back plate is made of hard material.

30. The case of claim 29, wherein the inner surface of the back plate is coated with a coating for preventing smudge between the back plate and the back portion of the electronic device.

31. The case of claim 30, wherein the coating is printed with a transparent dot array pattern using a UV (Ultra Violet) curable ink or silicone.

32. The case of claim 30, wherein the coating is made of acrylic or polyurethane or transparent UV (Ultra violet) curing material, or the coating is a hard coating.

33. The case of claim 29, wherein a matte PET (polyethylene terephthalate) film is attached to the inner surface of the back plate for preventing smudge between the back plate and the back portion of the electronic device, or
the matte PET (polyethylene terephthalate) film is attached to the back portion of the electronic device for preventing smudge between the back plate and the back portion of the electronic device.

34. The case of claim 29, wherein the inner surface of the back plate has a plurality of protrusions or embosses, wherein the protrusions or embosses are formed on the inner surface of the back plate by printing them on the back plate, or cutting the inner surface of the back plate, or molding the back plate to have the protrusions or embosses.

35. The case of claim 34, wherein the protrusions or embosses have a matte finish or the inner surface of the back plate has a matte finish.
